(19) United States
(12) Patent Application Publication
(10) Pub. No.: US 2007/0045212 A1
(43) Pub. Date: Mar. 1, 2007

(54) Transport-optimized crane undercarriage

(75) Inventors: Harald Riedinger, Zweibruecken (DE); Ingo Noeske, Zweibruecken (DE)

Correspondence Address: SIMPSON & SIMPSON, PLLC, 5555 MAIN STREET, WILLIAMSVILLE, NY, 14221-5406, US

(73) Assignee: Terex-Demag GmbH & Co. KG, Zweibruecken (DE)

(21) Appl. No.: 11/511,650

(22) Filed: Aug. 29, 2006

(30) Foreign Application Priority Data
Aug. 31, 2005 (DE) 10 2005 041 255.6

(51) Int. Cl. B66C 23/72

(52) U.S. Cl. 212/301

(57) ABSTRACT

The invention concerns a crane undercarriage (1) that comprises a center section (2), which is constructed for removable mounting of a rotatable crane superstructure (40), and a plurality of outriggers (4), which are pivotably supported on the center section (2) for assuming a transport configuration and at least one operational configuration. The support elements (10; 20) necessary for the operation of the crane are attachable on the outriggers (4). In addition, the invention concerns a variable crane that comprises a crane undercarriage of the above-mentioned type and selectively a set of crawlers (10) or a set of floor jacks (20) is removably mountable on the crane undercarriage (1).

### CROSS REFERENCE TO RELATED APPLICATIONS

This patent application claims priority of German Patent Application No. 10 2005 041 255.6, filed Aug. 31, 2005, which application is incorporated herein by reference.

### FIELD OF THE INVENTION

The present invention concerns a transport-optimized crane undercarriage that, in particular, in an exemplary embodiment of the invention, can be selectively utilized in a so-called CC-crane or a PC-crane. The first crane version concerns a so-called crawler crane. Such a crawler crane is distinguished by being movable on crawlers. The second crane version is a so-called pedestal crane, wherein the crane undercarriage is stationary on floor supports as, for example, floor plates.

### BACKGROUND OF THE INVENTION

Generally speaking, operators require more and more from cranes that can lift very large loads. Accordingly, the physical dimensions of such cranes are further increasing. In particular, lattice boom cranes are increasingly larger.

The support elements of such a crane, i.e., the components on which the entire crane stands, are different for each job site, and the environmental conditions that are found there and in particular the support elements depend from the nature of the ground at the job site for such a crane. Therefore, CC-cranes are sometimes used that are movable by means of crawlers. Typically, two mutually-opposing crawler side frames (such crawler side frames are also called crawler beams) are detachably affixed on the crane undercarriage for this purpose. For example, a crane undercarriage and/or crane pedestal is disclosed in EP 0 736 480 B1, on which a crawler side frame is removably connectable by pins on each of two mutually-opposing sides of the crane pedestal. According to the crawler crane with removably mountable crawler side frames known therefrom, the center section of the crane undercarriage is constructed with four outriggers; two outriggers extend essentially horizontally from the one side of the crane undercarriage and two outriggers extend essentially horizontally from the other side of the crane undercarriage. Support surfaces are formed at the ends of the outriggers for pin connection of the crawler side frame. The outriggers are rigidly formed on the center section, which is constructed for the removable connection of a rotatable crane superstructure.

The weight and dimensions of such a crane, in particular the longitudinal and diagonal dimensions, are limited by street traffic regulations. In order to also make large cranes transport-capable, a large crane is often disassembled into modules and/or individual parts that are transport-capable for the street. In the exemplary embodiment shown in the above-mentioned EP 0 736 480 B1, it is disclosed that each of the two outriggers, which extend from each side, are arranged so that they essentially do not project over the diameter of the center section that forms the rotary support. However, this design is not optimal with respect to stability and the distribution of forces.

A crane with four outriggers extending from the center section of the crane undercarriage and respective crawler side frames affixed thereon has been produced by the firm TAKRAF. The crane known under the model/trademark TAKRAF MZK 3000 includes a center section, two cross beams and four small crawler undercarriages. According to this known crane, the center section and the cross beams are releasably connected to each other. For transport, the cross beams are removed from the center section. As a result, the assembly and disassembly of such a crane requires significant work, whereby the assembly and disassembly times of such a crane increase. Accordingly, the operation and usage costs of such a crane are relatively high.

### SUMMARY OF THE INVENTION

According to one aspect of the present invention, a crane undercarriage is created that includes a center section that is constructed for detachable mounting of a rotatable crane superstructure. A plurality of outriggers is pivotably supported on the center section of the crane undercarriage. Thus, the outriggers can assume a transport configuration and at least one operational configuration without costly assembly work arising. Moreover, the outriggers of this crane undercarriage are constructed according the invention so that the support elements necessary for the crane operation are attachable thereon. The support elements can include crawler side frames or floor support elements as, e.g., pedestals or floor plates for the PC-crane version. For example, the pivoting of each of the outriggers takes place about an essentially vertical axis when the crane undercarriage is set horizontally.

The concept underlying the invention is to first create a crane undercarriage that is both transport-optimized and requires less assembly time. Due to the pivotable bearing of the outriggers on the center section of the crane undercarriage, transport on a conventional flat-bed truck is possible without anything further. In particular, transport can be performed in compliance with street traffic regulations. Due to the fact that the connections between the center section of the crane undercarriage and the outriggers are pivotable but are not detachable, the assumption of the operational configuration and thus the deployment of the crane are possible in a short time. Due to the pivotable design of the outriggers on the crane undercarriage center section, it is also possible without anything further to provide an optimized operational configuration when the crawler side frames are attached, as well as when the floor jacks are attached. In particular, when the crane undercarriage according to the present invention is intended for a PC-crane, the distance of the outriggers from each other can be optimized to achieve a large support surface. In other words, the distances of the ends of the outriggers are separated as far as possible from each other, so that a large “span width and/or support base” and thus a large support surface is realizable. For the case that an inventive crane undercarriage is envisioned to be a part of a CC-crane, an optimized configuration of the outriggers with respect to the track width of the crawlers is possible.

According to another aspect of the present invention, a crane undercarriage is created that comprises a compact center section having an outer circumference and a rotary support unit, the crane superstructure being detachably and rotatably mountable on the rotary support unit. A plurality of outriggers is pivotably supported on the outer circumference of the center section for assuming a transport configuration and at least one operational configuration. The outriggers are arranged and constructed to attach at least one of the group consisting of crawler tracks arranged and constructed to move the crane undercarriage on crawlers and floor support elements arranged and constructed to support the crane undercarriage in a stationary manner. A first group of outriggers are pivoted in a first direction into the transport configuration and a second group of outriggers are pivoted in a second direction into the transport configuration, the second direction being opposite the first direction.

For example, in an advantageous embodiment of the present invention, it can also be envisioned that the outriggers can assume several and/or different operational configurations, depending upon the type of support elements. That is, depending upon whether the crane undercarriage according to the present invention is envisioned to be a part of a PC-crane or a CC-crane, the outriggers can be oriented with respect to each other so as to be suitably optimized for the respective usage conditions, i.e., the respective optimized operational configurations are assumed. The transport configuration is preferably thus the same, in particular, so that a plurality of arms on one side of the center section and the other arms and/or outriggers on the other side are each pivotable, so that an oblong transport unit arises from the center section and the outriggers that are directed away from each other; the oblong transport unit is optimally transportable on a flat-bed truck.

The inventive design of a crane undercarriage can, but is not required to, be used for a PC-crane as well as a CC-crane. An exemplary embodiment of the invention envisions that an inventive crane undercarriage can be equipped with crawler side frames as well as with pedestals or floor plates in order to be used in one case as a CC-crane and in another case as a PC-crane.

In an exemplary embodiment of the present invention, instead of providing floor supports or floor plates, the inventive crane undercarriage is affixed, e.g., bolted, in or on a socket base similar to a pedestal. The socket base may be then, e.g., in turn variable in height, whereby the complete crane can be lifted.

It is nevertheless also conceivable that an inventive crane undercarriage is constructed only with the outriggers pivotably supported on the center section to receive crawler side frames or is constructed only to receive pedestals or floor plates or socket bases. In one of the cases, an inventive crane undercarriage is used only as a part of a CC-crane and in the other case as a part of a PC-crane. However, the version is preferable, in which the crane undercarriage can be furnished also with crawler side frames and/or crawler undercarriages or pedestals or the like, i.e., the respective support elements are detachably affixed on the outriggers and are designed so that their detachable connections on the center section of the crane undercarriage are identical. Thus, the usage width and the usability of an inventive crane undercarriage are broadened while simultaneously optimizing the transport thereof.

An exemplary design of an inventive crane envisions that the center section has an outer circumference on which four pivot hinges are formed; an outrigger is pivotably supported on each pivot hinge. This design facilitates an optimal enlargement of the support surface when the outriggers are located in the operational configuration. Moreover, it is thus possible without anything further to pivot the outriggers so that an optimal transport configuration can be assumed, as was already explained above, in particular so that transport is possible on a flat-bed truck or the same while complying with street traffic regulations.

A further exemplary embodiment of an inventive crane undercarriage envisions that the center section comprises an essentially pot-shaped base body, on which a rotary support unit is provided concentric to the central axis of the base body. The crane superstructure is rotatably mounted on the rotary support unit. This design of the rotary support unit is well known from the prior art and therefore does not require further detailed discussion.

For realizing a still larger support surface and/or support base, in particular when an inventive crane undercarriage is utilized in the PC-crane version, it is possible, e.g., to detachably affix outrigger extensions on the ends of the outriggers and to detachably attach the support elements, such as, e.g., crawler side frames or pedestals or the like, on the outrigger extensions. This inventive design facilitates an enlargement of the “span width and/or support base” of the outriggers located in the operational configuration. At the same time, however, an optimized transportability is continued to be provided by the detachability. Contrary to the prior art, only one pin connection or the same, i.e., the type of connection between the outrigger extension and the outrigger, must be released. As soon as the outrigger extensions are removed, the outriggers can be pivoted in the above-described manner in order to assume an optimized transport configuration.

As was already explained, the type of connection between the outrigger extension and the outrigger can take place in one of the ways common to crane design, in particular by a pin connection. It is nevertheless also possible to screw such an outrigger extension onto each end of the outriggers or to affix it in another way. Of course, it must be ensured that the connection permits the transmission of the not insubstantial forces and moments.

In particular, the invention also concerns a variable crane that comprises an inventive crane undercarriage of the above-described type and a set of crawlers as well as a set of pedestals or similar components. The set of crawlers is removably mounted on the outriggers of the crane undercarriage. In the mounted state of the crawler set, the crane is movable on the crawlers. When pedestals, socket bases or floor plates are removably mounted on the outriggers of the crane undercarriage instead of the set of crawlers, the crane is a PC-crane and rests on the floor jacks. A crane superstructure is also removably mountable on the crane; this crane superstructure is rotatable with respect to the crane undercarriage in the mounted state. Thus, a crane useable as a PC-crane as well as a CC-crane is created for the first time that is transport-optimized and is also optimally designed with respect to the assembly and disassembly time.

The attachment of the crawlers and/or the pedestals can take place in a well known manner, in particular by pin connections, etc. According to this variable crane, the crawler side frames and the floor jacks are at the positions that will be detachably connected with the outriggers of the center section of the crane undercarriage, preferably identically designed, so that they are mountable on the outriggers. Preferably, hydraulic- and/or pneumatic connections and/or electronic connections which may be provided are also designed the same, so that these can be connected at the respective connections on the outriggers. As a result, separate connections for the crawler side frames and the pedestals on the center section and/or on the outriggers are omitted.

The connection between the crane superstructure and the crane undercarriage takes places in the known type and way. Accordingly, a detailed explanation thereof is unnecessary.

### BRIEF DESCRIPTION OF THE DRAWINGS

In the following description and drawings, several embodiments of the invention are described in detail with reference to the appended drawings for further explanation and for a better understanding.

FIG. 1 shows a top view of an inventive crane undercarriage with outriggers pivotably supported on a center section, which outriggers are pivotable into a transport configuration;

FIG. 2 shows a side view of the inventive crane undercarriage according to FIG. 1;

FIG. 3 shows a perspective view of the inventive crane undercarriage shown in FIGS. 1 and 2 on a flat-bed trailer, in which the outriggers are pivoted into a transport configuration;

FIG. 4 shows a top view of the inventive crane undercarriage shown in FIGS. 1, 2 and 3, in which the outriggers are pivoted into an operational configuration;

FIG. 5 shows a top view of the inventive crane undercarriage according to one of FIGS. 1-4, wherein crawler side frames are each mounted on the ends of two outriggers;

FIG. 6 shows a side view of the crane undercarriage according to FIG. 5 that is provided with crawler side frames;

FIG. 7 shows a perspective view of the inventive crane undercarriage shown in FIG. 6;

FIG. 8 shows a top view of a further exemplary embodiment of the present invention, wherein outrigger extensions for extending the outriggers are removably or likewise pivotably attached to the individual outriggers;

FIG. 9 shows a perspective view of the inventive crane undercarriage shown in FIG. 8;

FIG. 10 shows a side view of an inventive crane undercarriage similar to the undercarriage as shown in FIGS. 8 and 9; and,

FIG. 11 shows a schematic side view of an inventive variable crane that is equipped with crawler side frames in this design.

### DETAILED DESCRIPTION OF THE EXEMPLARY EMBODIMENTS OF THE PRESENT INVENTION

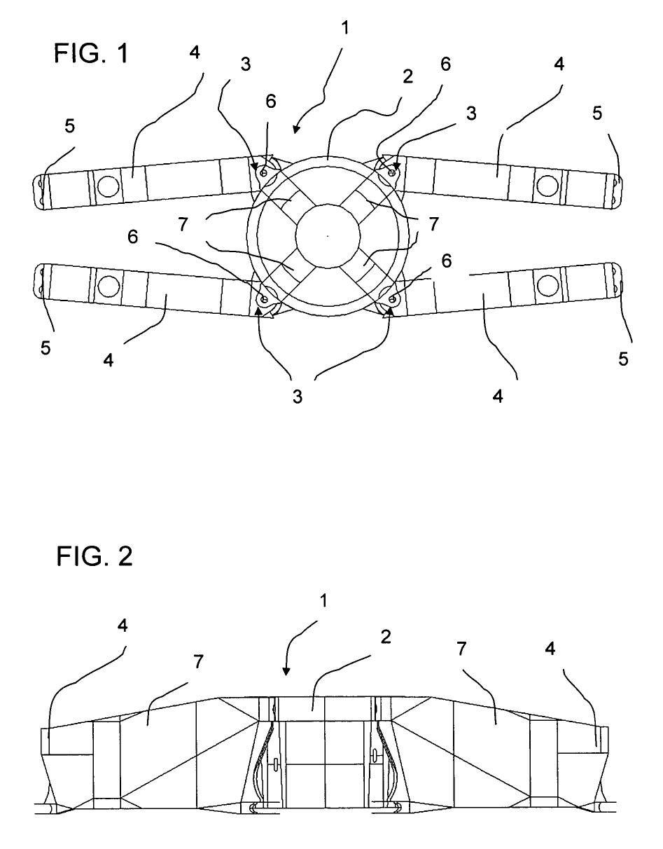

A first exemplary embodiment of the present invention will be described with reference to FIGS. 1-6. As is particularly apparent from the top view of the inventive crane undercarriage 1 shown in FIG. 1, the inventive crane undercarriage includes a center section that forms an essentially pot-shaped base body 2. This pot-shaped base body 2 is provided with a rotary support unit that is only schematically illustrated herein; the rotary support unit enables a removable attachment of a crane superstructure 40, which is illustrated only in FIG. 11 and is rotatable on the pot-shaped base body 2.

Four pivot hinges 3 in total are formed on the outer circumference of the pot-shaped base body 2 of the inventive crane undercarriage 1; an outrigger 4 that extends essentially horizontally and/or level with respect to the pot-shaped base body 2 is pivotably affixed on each of the pivot hinges 3. In the exemplary embodiment of an inventive crane undercarriage 1 shown herein, the pivot hinges 3 are disposed at 90° intervals with reference to the central axis of the base body 2. As is self-evident, it is also possible to provide other angles between the pivot hinges 3. For example, it is also possible to arrange the pivot hinges 3 lying on one side of a crane so that the angle defined between two pivot hinges 3 is greater than 90°, e.g., 120°. In this case, an optimized transport configuration is achievable, if need be.

Each of the pivot hinges 3 includes, e.g., an upper and a lower flange that project outwardly from the base body 2. One end of an outrigger 4 projects between the flanges, which lie one above the other. A pin 6 that forms the pivot hinge 3 extends through the end of the outrigger 4 and the two flange pieces.

A receiving device 5 exists on the outer end of each outrigger 4 and enables a removable attachment of support elements. The receiving device 5 can be formed, e.g., by a fastener, as is well known from the prior art.

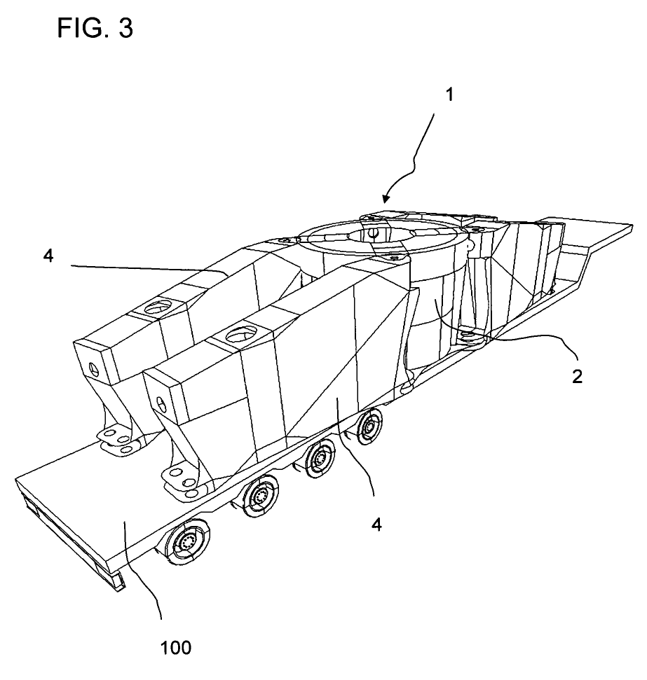

The side view of FIG. 2 shows a part of the inventive crane undercarriage 1, in particular the pot-shaped base body 2. As is apparent therefrom, the base body 2 possesses struts 7 that extend to the pivot hinges 3; the struts 7 increase the stiffness of the crane undercarriage 1 and enable the transfer of forces via the outriggers 4 and the support elements 10 and/or 20, which will be described below, to the ground. In addition, it is also referred to the perspective view of FIG. 3 of the crane undercarriage 1 lying on a flat-bed trailer 100 for transport; the crane undercarriage 1 on the flat-bed trailer 100 is identical with that shown in FIGS. 1 and 2. From the perspective view of FIG. 3 the dimensions of such an inventive crane undercarriage 1 is apparent. For example, the pot-shaped base body 2 may have a diameter of approximately 2 m or 2.5 to 4 m. The outriggers may have a length of approximately 2 m or more, in particular 3-4 m. It is understood that variations of the dimensions are possible, both above or below the aforementioned dimensions. In particular, all intermediate values of the aforementioned ranges are possible.

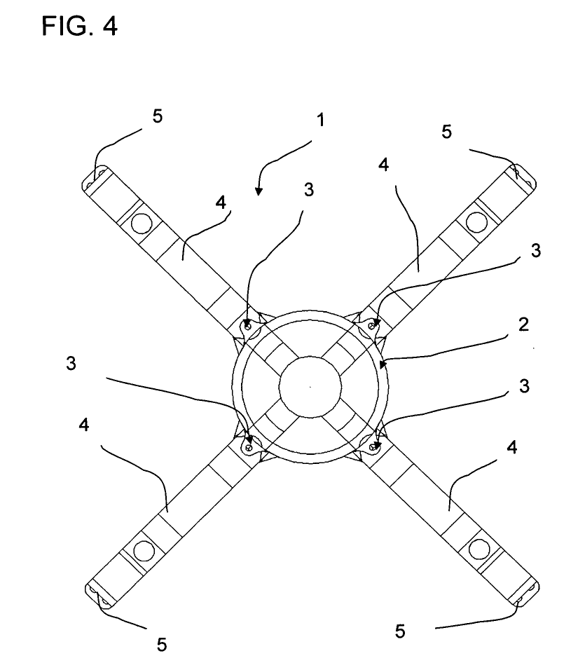

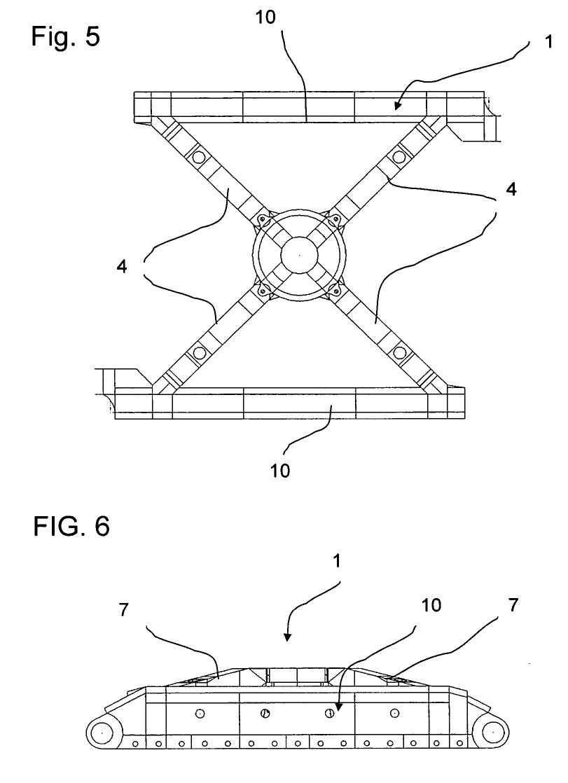

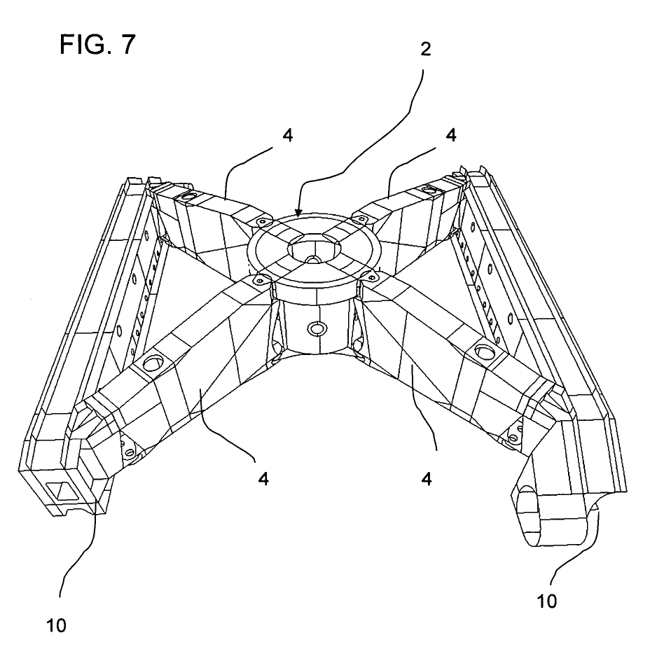

In FIG. 1, the outriggers 4 assume an optimized transport configuration. The crane undercarriage 1 with the pivot configuration of the outriggers 4 shown in FIG. 1 is laid longitudinally on a flat-bed truck and transported to the next job site. At the job site, the outriggers 4 are then pivoted into the operational configuration shown in FIG. 4 or 5 and are optionally locked in this operational configuration. If the crane undercarriage is utilized as a CC-crane, a crawler side frame 10 will then be mounted onto two respective outriggers 4, as shown in FIGS. 5 and/or 6 and in the perspective view shown in FIG. 7. It is self-evidently also possible that a separate crawler side frame 10 will be affixed onto each outrigger 4, as is known, e.g., from the TAKRAF MKZ 3000 discussed above. The connection of the outrigger 4 and the respective crawler side frame 10 takes place by means of the known pin connection. For example, the pin connection known from EP 0 736 480 can be utilized.

The perspective view of the inventive crane undercarriage 1 according to FIG. 7 shows in particular also the connecting points between the crawler side frames 10 and the outriggers 4.

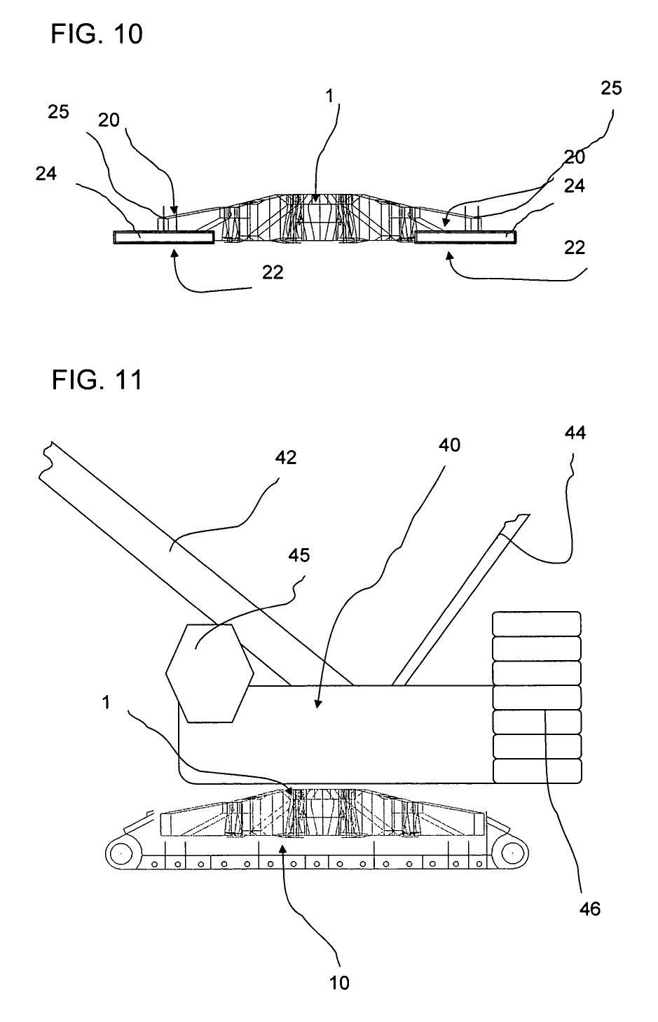

Alternative to the embodiment shown in FIG. 5, instead of the crawler side frames 10, pedestals 22 could also be removably affixed to each outrigger 4, as schematically shown in FIG. 10. In this case, floor plates 24 are detachably or removable affixed to the ends of the outriggers 4 via stanchions 25.

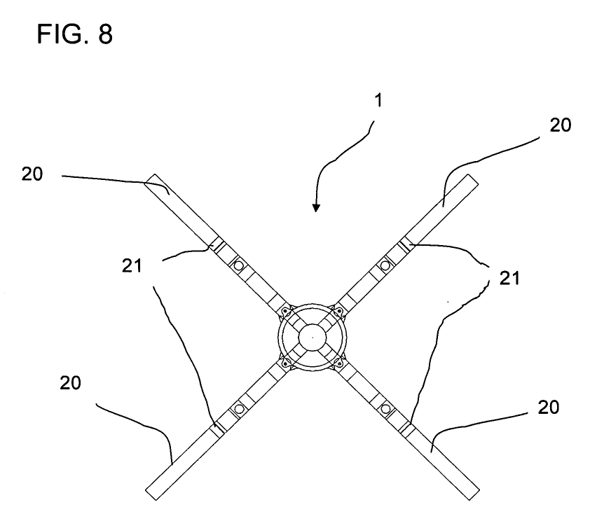

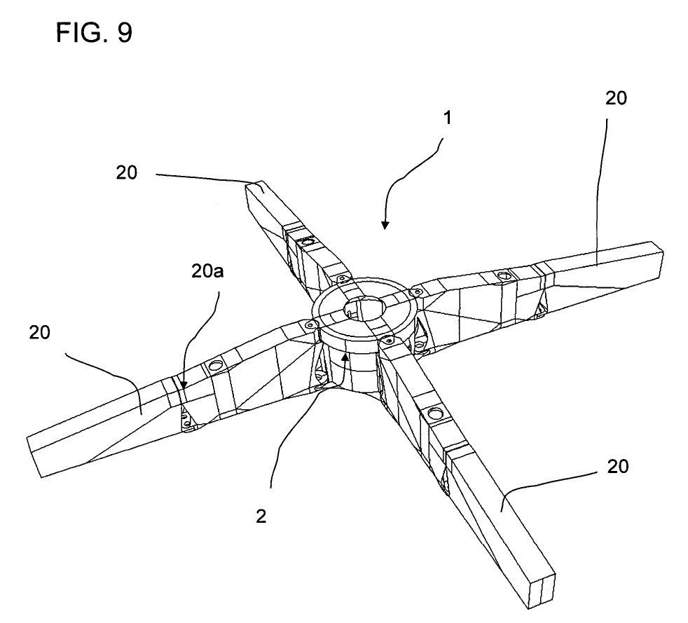

A further exemplary embodiment of the present invention is shown in FIGS. 8 and 9. In this embodiment, outrigger extensions 20 are detachably mounted at mounting flanges 21 on the outer ends 20a of the outriggers 4 for enlarging the support surface; crawler side frames 10 or pedestals 22 are then mounted on the outer ends of the outrigger extensions 20.

In FIG. 10, the crane undercarriage 1 according to the present invention, as shown in FIG. 7, supplemented by the outrigger extensions 20 is shown in side view and in particular the pedestals 22 are visible herein; the pedestals 22 are detachably affixed on the outer ends of the outrigger extensions 20. The perspective view of the crane undercarriage 1 according to FIG. 9 shows in particular the connecting points between the outriggers 4 and the outer beams or outrigger extensions 20.

Finally, the schematic side view according to FIG. 11 shows an inventive variable crane with crane undercarriage 1; a plurality of outriggers 4 are affixed on the crane undercarriage 1 so as to be pivotably supported. A crane superstructure 40 with a driver's cabin 45 is mounted on the crane undercarriage 1 according to the present invention; during operation, the crane superstructure 40 is rotatable with respect to the crane undercarriage 1. In the embodiment of the present invention shown in FIG. 11, the crane is constructed as a CC-crane and accordingly, crawler side frames 10 are detachably mounted on the inventive crane undercarriage 1. It should be noted that the inventive crane superstructure 40 includes a counterweight 46 as well as a lattice boom 42 that is braced by a derrick boom 44. The elements are shown only schematically in FIG. 11 and correspond to the prior art, so that further explanations concerning these elements are not required.

What is claimed is:

1. A crane undercarriage comprising:
a center section constructed for detachable mounting of a rotatable crane superstructure,
a plurality of outriggers pivotably supported on the center section for assuming a transport configuration and at least one operational configuration, wherein the outriggers are adapted to attach support elements necessary for operation of the crane.

2. The crane undercarriage according to claim 1, wherein the center section has an outer circumference on which at least four pivot hinges are formed, one outrigger being rotatably supported on each of the pivot hinges.

3. The crane undercarriage according to claim 1, wherein the outriggers are lockable in at least one operational configuration.

4. The crane undercarriage according to claim 1, wherein the center section has an outer circumference on which at least four pivot hinges are formed, one outrigger being rotatably supported on each of the pivot hinges, wherein each pivot hinge is such constructed that the associated outrigger is lockable in at least one operational configuration.

5. The crane undercarriage according to claim 1, wherein a first group of outriggers is pivoted in a first direction into the transport configuration and a second group of outriggers is pivoted in a second direction into the transport configuration, the second direction being opposite the first direction.

6. The crane undercarriage according to claim 1, wherein the center section comprises an essentially pot-shaped base body having a central axis, a rotary support unit being provided on the base body coaxial to the central axis of the base body, the crane superstructure being rotatably mountable on the rotary support unit.

7. The crane undercarriage according to claim 1, wherein the support elements mountable on the outriggers are crawler side frames.

8. The crane undercarriage according to claim 1, wherein the support elements mountable on the outriggers are floor support plates.

9. The crane undercarriage according to claim 1, wherein each outrigger is composed of a plurality of segments that are pivotable against each other by a pivot hinge for transport.

10. The crane undercarriage according to claim 9, wherein the segments of an outrigger are lockable against each other at least in their operational configuration.

11. The crane undercarriage according to claim 1, wherein an outrigger extension is detachably affixed on each outer end of an outrigger and the support elements are to be detachably attached to the outrigger extensions.

12. The crane undercarriage according to claim 1, wherein an outrigger extension is pivotably affixed on each end of an outrigger and the support elements are to be detachably attached to the outrigger extensions.

13. A crane undercarriage comprising:
a compact center section having an outer circumference and a rotary support unit, the crane superstructure being detachably and rotatably mountable on the rotary support unit,
a plurality of outriggers pivotably supported on the outer circumference of the center section for assuming a transport configuration and at least one operational configuration, wherein the outriggers are arranged and constructed to attach at least one of the group consisting of crawler tracks arranged and constructed to move the crane undercarriage on crawlers and floor support elements arranged and constructed to support the crane undercarriage in a stationary manner,
wherein a first group of outriggers are pivoted in a first direction into the transport configuration and a second group of outriggers are pivoted in a second direction into the transport configuration, the second direction being opposed to the first direction.

14. The crane undercarriage according to claim 13, wherein:
the rotary support unit has a central axis, the crane superstructure being rotatably around the central axis; and,
the center section has formed on its outer circumference four pivot hinges having pivot axis directed in the same direction as the central axis, on each pivot hinge one outrigger being rotatably supported.

15. A crane to be used as a CC-crane or a PC-crane, comprising:
a crane undercarriage including a center section constructed for detachable mounting of a rotatable crane superstructure, a plurality of outriggers pivotably supported on the center section for assuming a transport configuration and at least one operational configuration, wherein the outriggers are adapted to attach support elements necessary for operation of the crane;
a set of crawlers removably mountable on the outriggers of the crane undercarriage, wherein the crane is movable on the crawlers when the crawler set is mounted;
a set of floor plates removably mountable on the outriggers of the crane undercarriage, wherein the crane rests on the floor plates when the floor plates are mounted; and,
a crane superstructure removably mountable on the crane undercarriage and being rotatable with respect to the crane undercarriage in the mounted state.
